(19) United States
(12) Patent Application Publication
(10) Pub. No.: US 2008/0104797 A1
(43) Pub. Date: May 8, 2008

(54) Rotatable hinge

(75) Inventors: Chia-Ko Chung, Shulin City (TW); Jia-Yan Jian, Shulin City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SHIN ZU SHING CO., LTD., Shulin City (TW)

(21) Appl. No.: 11/592,545

(22) Filed: Nov. 3, 2006

(51) Int. Cl. E05D 7/00

(52) U.S. Cl. 16/224

(57) ABSTRACT

A rotatable hinge has a stationary bracket, a positioning washer, a biasing washer, a limit ring, a rotating bracket, a keyed washer and a keyed pivot rivet. The keyed pivot rivet has a distal end. The distal end of the keyed pivot rivet extends through the biasing washer, the positioning washer, the stationary bracket, the limit ring, the rotating bracket and the keyed washer and is expanded to hold the rotatable hinge together. The rotatable hinge has a simplified structure and is easy to manufacture.

### BACKGROUND OF THE INVENTION

1. Field of the Invention

The present invention relates to a hinge, and more particularity to a hinge that needs fewer parts to manufacture.

2. Description of Related Art

Rotatable hinges are used in many businesses especially stores to connect two electronic devices to save space. For example, a mouse and a bar code reader have individual footprints that can be reduced to a single footprint by connecting the bar code reader to the mouse with a rotatably hinge. Such a hinge may be used by electrical devices, such as a personal digital assistant (PDA), a cell phone, a portable video game machine or a portable video player.

With reference to FIGS. 6 and 7, a conventional rotatable hinge for an electrical device in accordance with the prior art comprises a rotating bracket (30), a keyed pivot rod (50), a limit ring (33), a rotating bracket (40), a positioning washer (44), a biasing washer and a C-ring (52).

The rotating bracket (30) is attached securely to a device and has an inner face, a keyed central through hole (31) and two driving protrusions (32). The keyed central through hole (31) is basically circular, is formed through the rotating bracket (30) and has at least one flat surface. The driving protrusions (32) are formed on and protrude from the inner face of the rotating bracket (30) and correspond to each other.

The keyed pivot rod (50) is cylindrical, corresponds to and is mounted in the keyed central through hole (31) in the rotating bracket (30) and has a distal end, and an annular groove (51). The annular groove (51) is formed around the keyed pivot rod (50) near the distal end.

The limit ring (33) is mounted rotatably around the keyed pivot rod (50), is rotated by the driving protrusions (32) on the rotating bracket (30) and has a central through hole (35), an outer edge and a limit (34). The central through hole (35) is circular and is mounted rotatably on the keyed picot rod (50). The limit (34) is formed on and protrudes out from the outer edge of the limit ring (33) and is rotated by one of the driving protrusions (32) when the rotating bracket (30) rotates.

The rotating bracket (40) is attached securely to another device and has an inner face, an outer face, a central through hole (42) and two positive stops (41). The central through hole (42) is circular, is mounted rotatably on the keyed pivot rod (50) and has an inner edge and four radial slots (43). The radial slots (43) are formed in the inner edge of the central hole (42) and communicate with the outer face, and adjacent radial slots (43) are separated by 90°. The positive stops (41) are formed on and protrude from the inner face of the rotating bracket (40), are separated by a specific angular separation and limit rotation of the rotating bracket (30) to the angular separation between the positive stops (41).

The positioning washer (44) has an inner face, an outer face, a keyed central through hole (46) and two ribs (45). The keyed central through hole (46) corresponds to and is mounted on the keyed pivot rod (50) rotatably against the outer face of the stationary bracket (40) and rotates with the keyed pivot rod (50) and the rotating bracket (30). The ribs (45) are formed radially on the inner face of the positioning washer (44) diametrically opposite to each other and selectively engage radial slots (43) in the rotating bracket (40) to hold the rotating bracket (30) in position relative to the stationary bracket (40).

The biasing washer is mounted against the outer face of the positioning washer (44) and presses the positioning washer (44) against the outer face of the stationary bracket (40) and has an outer face.

The C-ring (52) is mounted in the annular groove (51) in the keyed pivot rod (50) to hold the rotating bracket (30), the limit ring (33), the rotating bracket (40), the positioning washer (44) and the biasing washer on the keyed pivot rod (50).

Even though the conventional rotatable hinge allows an electrical device to rotate and be held in a specific position, the conventional rotatable hinge has a complicated structure that makes the hinge difficult to manufacture.

To overcome the shortcomings, the present invention provides a hinge to obviate or mitigate the aforementioned problems.

### SUMMARY OF THE INVENTION

The primary objective of the present invention is to provide a rotatable hinge that has a simple structure and is easy to manufacture.

The rotatable hinge in accordance with the present invention has a positioning washer, a stationary bracket, a biasing washer, a limit ring, a rotating bracket, a keyed washer and a keyed pivot rivet. The keyed pivot rivet has a distal end. The distal end of the keyed pivot rivet extends through the biasing washer, the positioning washer, the stationary bracket, the limit ring, the rotating bracket and the keyed washer and is expanded to hold the rotatable hinge together. The rotatable hinge has a simpler structure than a conventional hinge is easier to manufacture.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge in accordance with the present invention when the hinge is rotated 180°;

FIG. 2 is a perspective view of the hinge in FIG. 1;

FIG. 3 is a side view of the hinge in FIG. 2;

FIG. 4 is cross sectional top view of the hinge in FIG. 3;

FIG. 5 is an operational cross sectional top view of the hinge after a rotating bracket is turned;

FIG. 6 is an exploded perspective view of a conventional hinge in accordance with the prior art; and

FIG. 7 is a perspective view of the conventional hinge in FIG. 6.

### DETAILED DESCRIPTION OF THE PREFERRED EMBODIMENT

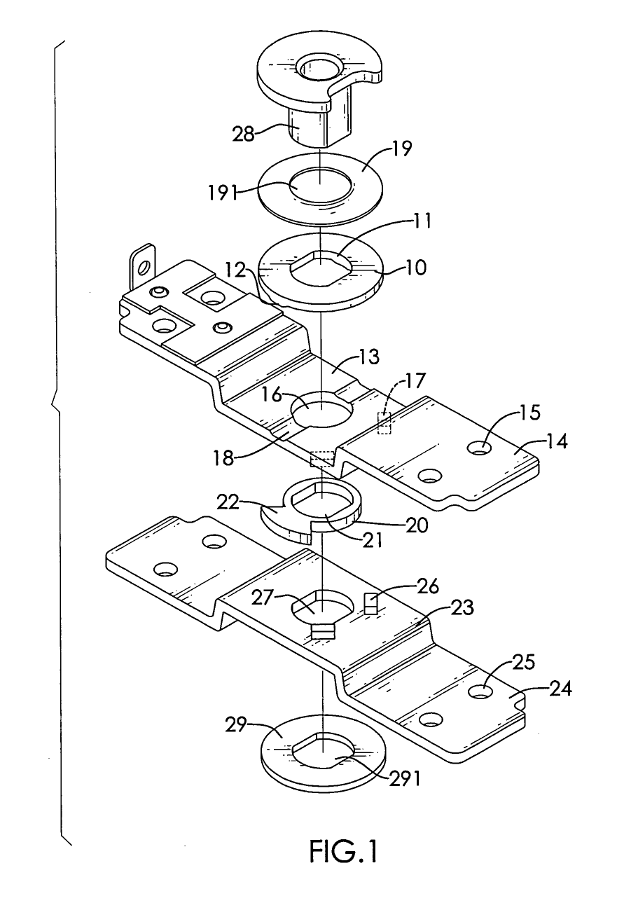

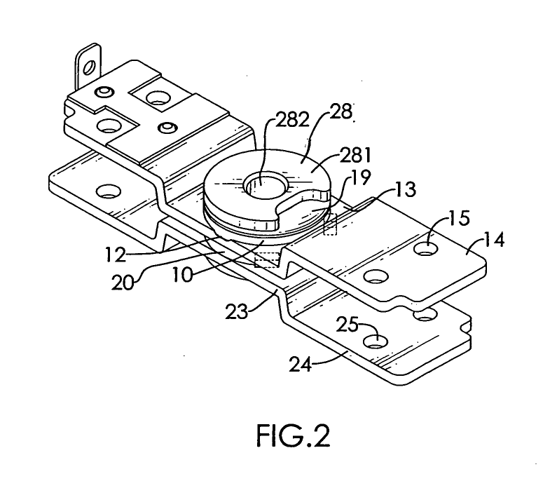

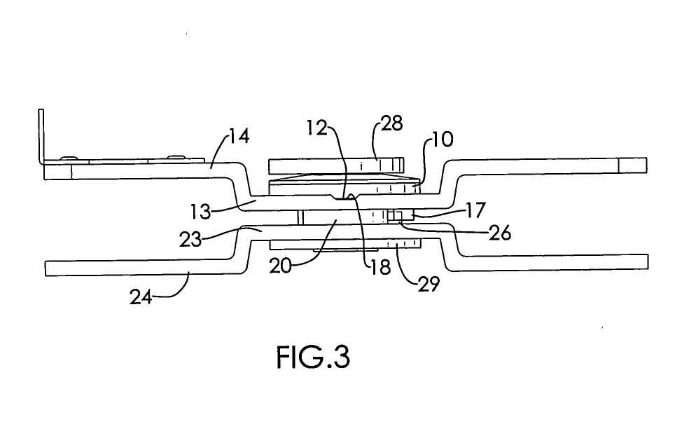

With reference to FIGS. 1, 2 and 3, a rotatable hinge in accordance with the present invention comprises a stationary bracket (13), a positioning washer (10), a biasing washer (19), a limit ring (20), a rotating bracket (23) and a keyed washer (29) and a keyed pivot rivet (28).

The stationary bracket (13) has two ends, two optional wings (14), a central through hole (16), an inner face, an outer face, two positive stops (17) and two detents (18). The wings (14) are formed respectively on and protrude longitudinally out from the ends of the stationary bracket (13), and each wing (14) has at least one screw hole (15). The screw holes (15) are formed through the wings (14) of the stationary bracket (13) and are used to attach the stationary bracket (13) to a device. The central hole (16) is circular and is formed through the stationary bracket (13) between the ends. The positive stops (17) are formed on and protrude away from the inner face of the stationary bracket (13) and are separated from each other by an angular separation. The detents (18) are formed on the outer face of the stationary bracket (13) near the central through hole (16) in the stationary bracket (13) diametrically opposite to each other.

The positioning washer (10) has an inner face, a keyed central through hole (11) and two protrusions (12). The keyed central through hole (11) is formed coaxially through the positioning washer (10) and has at least one circular section and at least one flat section. The two protrusions (12) are formed diametrically opposite to each other on and protrude from the inner face of the positioning washer (10) near the keyed central through hole (11) in the positioning washer (10) and selectively align with and engage the detents (18) to hold the rotating bracket (13) in position relative to the positioning washer (10).

The biasing washer (19) presses the positioning washer (10) against the rotating bracket (13) and has a central through hole (191). The central through hole (191) is circular, corresponds to the central through hole (16) in the rotating bracket (13) and is formed coaxially through the biasing washer (19).

The limit ring (20) is mounted rotatably against the inner face of the rotating bracket (13) and has a rotatable face, a stationary face, an outer edge, a limit (22) and a keyed central through hole (21). The rotatable face rotatably abuts the inner surface of the stationary bracket (13) around the central through hole (16). The limit (22) is formed on and protrudes out from the outer edge of the limit ring (20) and selectively contacts one of the positive stops (17) on the stationary bracket (13) to stop the rotating bracket (13) from rotating. The keyed central through hole (21) corresponds to and aligns with the central through hole in the positioning washer (10) and is formed coaxially through the limit ring (20).

The rotating bracket (23) has an inner face, an outer face, two ends, two optional wings (24), two protrusions (26) and a keyed central through hole (27). The inner face abuts the limit ring (20). The wings (24) are formed respectively on and protrude longitudinally from the ends of the rotating bracket (23), and each wing (24) has at least one screw hole (25). The screw holes (25) are formed through the wings (24) of the rotating bracket (23) and are used to attach the rotating bracket (23) to a device. The protrusions (26) are formed on and protrude away from the inner face of the rotating bracket (23) and are separated from each other by an angular separation. The keyed central through hole (27) is formed through the rotating bracket (23) between the ends and corresponds to the keyed central through hole (21) in the limit ring (20) and the keyed central through hole (11) in the positioning washer (10).

The keyed washer (29) is mounted on the outer face of the rotating bracket (23) concentrically around the keyed central through hole (27) in the rotating bracket (23) and has an inner face, an outer face and a keyed central through hole (291). The inner face is mounted against the outer face of the rotating bracket (23) around the keyed central through hole (27) in the rotating bracket (23). The keyed central through hole (291) corresponds to and is mounted concentrically against the keyed central through hole (27) in the rotating bracket (23) and has an edge.

The keyed pivot rivet (28) is tubular, corresponds to the keyed central through holes (11, 21, 27, 291) respectively in the positioning washer (10), the limit ring (20), the rotating bracket (23) and the keyed washer (29), is mounted through the central through holes (191, 11, 16, 21, 27, 291) respectively in the biasing washer (19), the positioning washer (10), the stationary bracket (13), the limit ring (20), the rotating bracket (23) and the keyed washer (29), holds the rotatable hinge together and has a proximal end, an enlarged head (281), a distal end and an optional central through hole (282). The enlarged head (281) is formed around and protrudes radially out from the proximal end of the keyed pivot rivet (28) and presses against the biasing washer (19). The distal end protrudes from keyed central through hole (291) of the keyed washer (29) and is expanded beyond the edge of the keyed central through hole (291) in the keyed washer (29) to securely hold the rotatable hinge together. The central through hole (282) is formed coaxially through the keyed pivot rivet (28) and makes expanding the distal end easy.

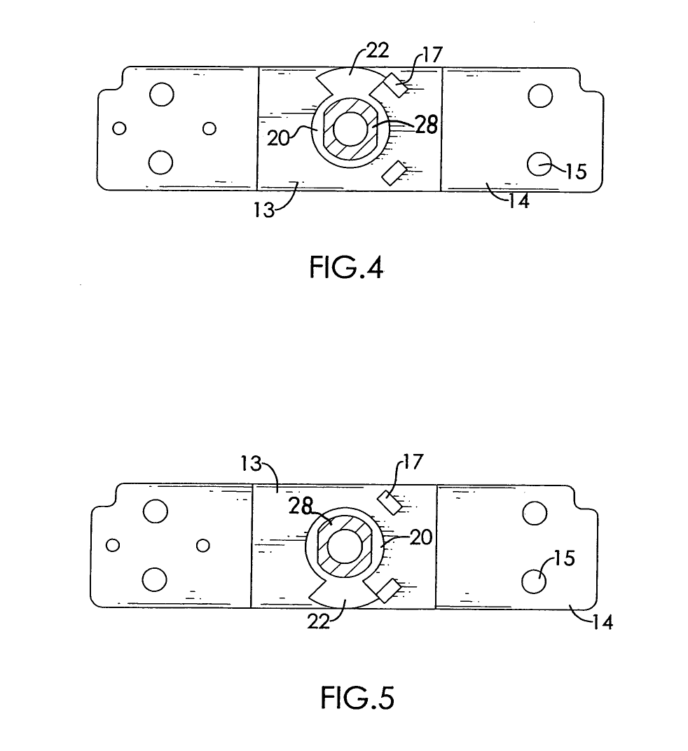

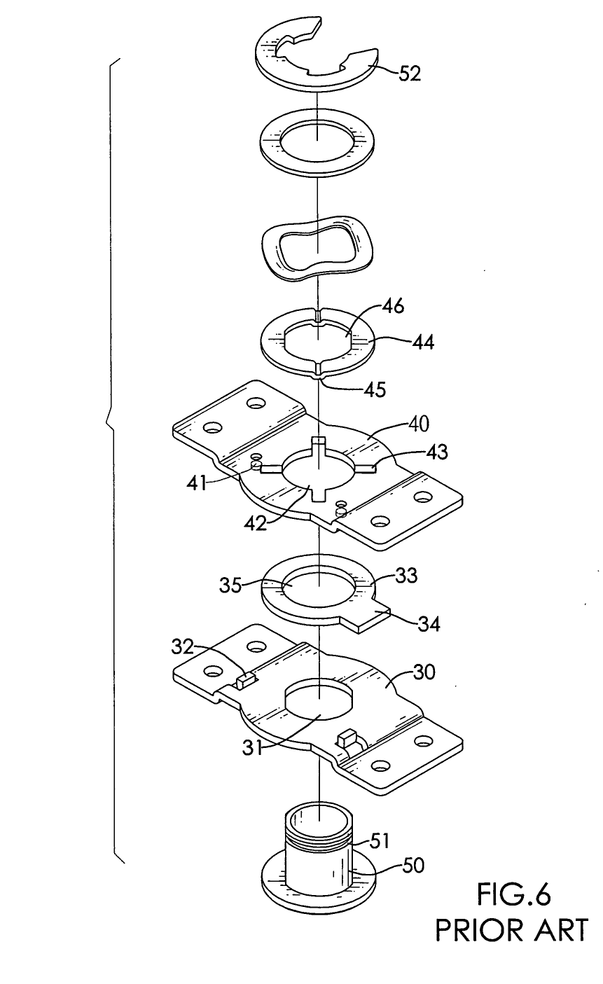

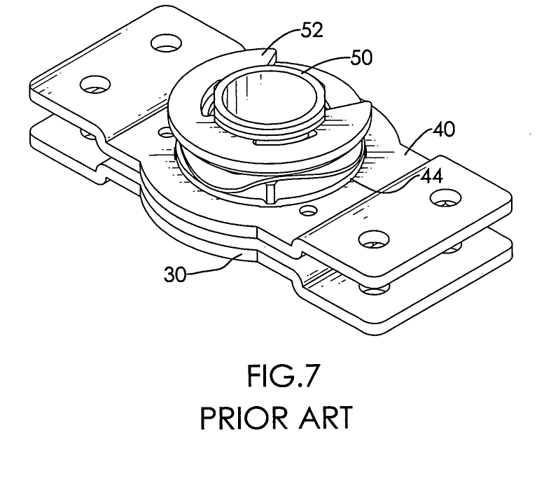

With further reference to FIGS. 4 and 5, the keyed pivot rivet (28) rotates when the rotating bracket (23) rotates and rotates the positioning washer (10) and the limit ring (20). A force applied to the rotating bracket (23) causes the protrusions (12) to disengage from the detents (18) in the outer surface of the stationary bracket (13) and compress the biasing washer (19). When the protrusions (12) align respectively with the detents (18), the biasing washer (19) presses the protrusions (12) respectively into the detents (18) to hold the rotating bracket (23) in position. When the protrusions (12) engage the detents (18), the limit (22) on the limit ring (20) strikes the corresponding positive stop (17) on the stationary bracket (13) to stop the rotating bracket (23) and keep the protrusions (12) from rotating beyond the detents (18).

A structure descried above, the rotatable hinge has a simpler structure than a conventional hinge and is easy to manufacture.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A rotatable hinge comprising
a stationary bracket having
two ends;
a central through hole being circular and being formed through the stationary bracket between the ends;
an inner face;
an outer face;
two positive stops being formed on and protruding away from the inner face of the stationary bracket and being separated from each other by an angular separation; and
two detents being formed on the outer face of the stationary bracket near the central through hole in the stationary bracket diametrically opposite to each other;
a positioning washer having
an inner face;
a keyed central through hole being formed coaxially through the positioning washer and having
at least one circular section; and
at least one flat section; and
two protrusions being formed diametrically opposite to each other on and protruding from the inner face of the positioning washer near the keyed central through hole in the positioning washer and selectively aligning with and engaging the detents to hold the rotating bracket in position relative to the positioning washer;
a biasing washer pressing the positioning washer against the rotating bracket and having a central through hole being circular, corresponding to the central through hole in the rotating bracket and being formed coaxially through the biasing washer;
a limit ring being mounted rotatably against the inner face of the rotating bracket and having
a rotatable face rotatably abutting the inner surface of the stationary bracket around the central through hole;
a stationary face;
an outer edge;
a limit being formed on and protruding out from the outer edge of the limit ring and selectively abutting one of the positive stops on the stationary bracket; and
a keyed central through hole corresponding to and aligning with the central through hole in the positioning washer and being formed coaxially through the limit ring;
a rotating bracket having
an inner face abutting the limit ring;
an outer face;
two ends; and
a keyed central through hole being formed through the rotating bracket and corresponding to the keyed central through hole in the limit ring and the keyed central through hole in the positioning washer;
a keyed washer being mounted on the outer face of the rotating bracket concentrically around the keyed central through hole in the rotating bracket and having
an inner face being mounted against the outer face of the rotating bracket around the keyed central through hole in the rotating bracket;
an outer face; and
a keyed central through hole corresponding to and being mounted concentrically against the keyed central through hole in the rotating bracket and having an edge; and
a keyed pivot rivet being tubular, corresponding to the keyed central through holes respectively in the positioning washer, the limit ring, the rotating bracket and the keyed washer, being mounted through the central through holes respectively in the biasing washer, the positioning washer, the stationary bracket, the limit ring, the rotating bracket and the keyed washer, holding the rotatable hinge together and having
a proximal end;
an enlarged head being formed around and protruding radially out from the proximal end of the keyed pivot rivet and pressing against the biasing washer; and
a distal end protruding from the keyed central through hole in the keyed washer and being expanded beyond the edge of the keyed central through hole in the keyed washer to securely hold the rotatable hinge together.

2. The rotatable hinge as claimed in claim 1, wherein
the rotating bracket further has two wings formed respectively on and protruding longitudinally from the ends of the rotating bracket, and each wing has at least one screw hole formed through the wing;
the stationary bracket further has two wings formed respectively on and protruding longitudinally out from the ends of the rotating bracket, and each wing has at least one screw hole formed through the wing.
